(19) United States
(12) Patent Application Publication
(10) Pub. No.: US 2006/0010276 A1
(43) Pub. Date: Jan. 12, 2006

(54) Isolation of input/output adapter direct memory access addressing domains

(75) Inventors: Richard Louis Arndt, Austin, TX (US); Patrick Allen Buckland, Austin, TX (US); Gregory Michael Nordstrom, Pine Island, MN (US); Steven Mark Thurber, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/887,522

(22) Filed: Jul. 8, 2004

(51) Int. Cl. G06F 13/14

(52) U.S. Cl. 710/305

(57) ABSTRACT

Method, apparatus and system for isolating input/output adapter Direct Memory Access addressing domains in a data processing system. The data processing system includes a plurality of input/output adapters, and access to a memory of the data processing system by the plurality of input/output adapters is controlled by functionality in a host bridge that connects the plurality of input/output adapters to a system bus of the data processing system, thus permitting the use of low cost, industry standard switches and bridges external to the host bridge.

### CROSS REFERENCE TO RELATED APPLICATIONS

The present application is related to co-pending applications entitled “ISOLATION OF INPUT/OUTPUT ADAPTER ERROR DOMAINS”, Ser. No. ______, attorney docket no. AUS920040094US1; and “ISOLATION OF INPUT/OUTPUT ADAPTER INTERRUPT DOMAINS”, Ser. No. ______, attorney docket no. AUS920040095US1, all filed on even date herewith. All the above related applications are assigned to the same assignee and are incorporated herein by reference.

### BACKGROUND OF THE INVENTION

1. Technical Field

The present invention relates generally to the data processing field and, more particularly, to a method, apparatus and system for isolating input/output adapter Direct Memory Access addressing domains in a data processing system.

2. Description of Related Art

In a server environment, it is important to be able to isolate input/output adapters (IOAs) so that an IOA can only obtain access to the resources which are allocated to it. Isolating IOAs from one another is important to create a system that is robust from a reliability and availability standpoint, and is especially important in a logical partitioned (LPAR) data processing system, so that IOAs, or parts of IOAs, can be allocated on an individual basis to different LPAR partitions.

In particular, in an LPAR data processing system, multiple operating systems or multiple copies of a single operating system are run on a single data processing system platform. Each operating system or operating system copy executing within the data processing system is assigned to a different logical partition, and each partition is allocated a non-overlapping subset of the resources of the platform. Thus, each operating system or operating system copy directly controls a distinct set of allocatable resources within the platform.

Among the platform resources that may be allocated to different partitions in an LPAR data processing system include regions of system memory and IOAs or parts of IOAs. Thus, different regions of system memory and different IOAs or parts of IOAs may be assigned to different partitions of the system. In such an environment, it is important that the platform provide a mechanism to enable IOAs or parts of IOAs to obtain access to all the physical memory that they require to properly service the partition or partitions to which they have been assigned; while, at the same time prevent IOAs or parts of IOAs from obtaining access to physical memory that has not been allocated to their associated partitions.

Physical memory assigned to different partitions is interspersed throughout the physical memory address range of a platform. Accordingly, it is not realistic for IOAs or parts of IOAs to be given direct access to a physical memory address from an I/O bus address and, at the same time, effectively prevent IOAs or parts of IOAs from gaining access to memory that they are not supposed to access.

Currently, isolation of memory addresses between IOAs is accomplished by using unique, specially designed bridge chips that are located externally of the PCI (Peripheral Component Interconnect) Host Bridge (PHB) in conjunction with a translation mechanism such as Translation Control Entries or TCEs (see commonly assigned U.S. Pat. No. 6,629,162 entitled “SYSTEM, METHOD AND PRODUCT IN A LOGICALLY PARTITIONED SYSTEM FOR PROHIBITING I/O ADAPTERS FROM ACCESSING MEMORY ASSIGNED TO OTHER PARTITONS DURING DMA”). Such unique bridge chips are relatively expensive and preclude the use of less costly, industry standard bridges in the data processing system.

It would, accordingly, be advantageous to provide for isolation of the memory address range available to IOAs or parts of IOAs in a data processing system without requiring the use of expensive, unique bridge chips.

### SUMMARY OF THE INVENTION

The present invention provides a method, apparatus and system for isolating input/output adapter Direct Memory Access addressing domains in a data processing system. The data processing system includes a plurality of input/output adapters, and access to a memory of the data processing system by the plurality of input/output adapters is controlled by functionality in a host bridge that connects the plurality of input/output adapters to a system bus of the data processing system, thus permitting the use of low cost, industry standard switches and bridges external to the host bridge.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a block diagram of an exemplary logical partitioned platform in which the present invention may be implemented;

FIG. 3 is a block diagram that illustrates a known system for providing resource isolation in a data processing system to assist in explaining the present invention;

FIG. 4 is a block diagram that illustrates a system for providing resource isolation in a data processing system in accordance with a preferred embodiment of the present invention;

FIG. 5 is a conceptual flow diagram that illustrates an operation for isolating Direct Memory Access addressing domains in a data processing system in accordance with a preferred embodiment of the present invention; and

FIG. 6 is a flowchart that illustrates a method for isolating Direct Memory Access addressing domains in a data processing system in accordance with a preferred embodiment of the present invention.

### DETAILED DESCRIPTION OF THE PREFERRED EMBODIMENT

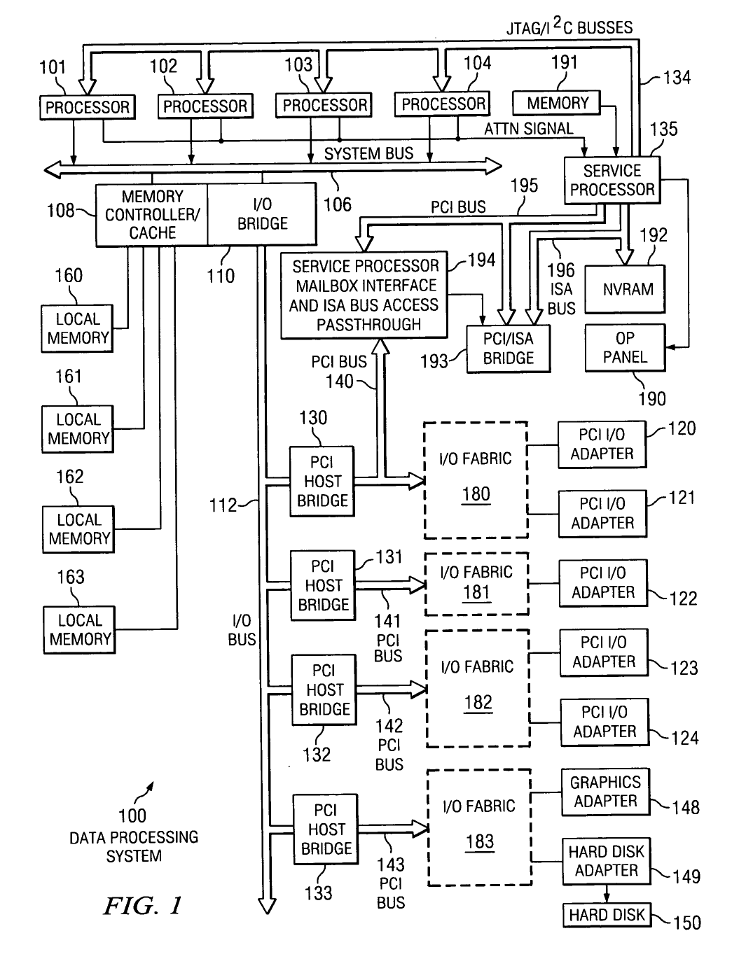

With reference now to the figures, FIG. 1, depicts a block diagram of a data processing system in which the present invention may be implemented. Data processing system 100 may be a symmetric multiprocessor (SMP) system including a plurality of processors 101, 102, 103, and 104 connected to system bus 106. For example, data processing system 100 may be an IBM eServer, a product of International Business Machines Corporation in Armonk, New York, implemented as a server within a network. Alternatively, a single processor system may be employed. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logical partitioned (LPAR) data processing system, however, it should be understood that the invention is not limited to an LPAR system but can also be implemented in other data processing systems. LPAR data processing system 100 has multiple heterogeneous operating systems (or multiple copies of a single operating system) running simultaneously. Each of these multiple operating systems may have any number of software programs executing within it. Data processing system 100 is logically partitioned such that different PCI input/output adapters (IOAs) 120, 121, 122, 123 and 124, graphics adapter 148 and hard disk adapter 149, or parts thereof, may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI IOAs 120-124, graphics adapter 148, hard disk adapter 149, each of host processors 101-104, and memory from local memories 160-163 is assigned to each of the three partitions. In this example, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and PCI IOAs 121, 123 and 124 may be assigned to logical partition P1; processors 102-103, some portion of memory from local memories 160-163, and PCI IOAs 120 and 122 may be assigned to partition P2; and processor 104, some portion of memory from local memories 160-163, graphics adapter 148 and hard disk adapter 149 may be assigned to logical partition P3.

Each operating system executing within a logically partitioned data processing system 100 is assigned to a different logical partition. Thus, each operating system executing within data processing system 100 may access only those IOAs that are within its logical partition. For example, one instance of the Advanced Interactive Executive (AIX) operating system may be executing within partition P1, a second instance (copy) of the AIX operating system may be executing within partition P2, and a Linux or OS/400 operating system may be operating within logical partition P3.

Peripheral component interconnect (PCI) host bridges (PHBs) 130, 131, 132 and 133 are connected to I/O bus 112 and provide interfaces to PCI local busses 140, 141, 142 and 143, respectively. PCI IOAs 120-121 are connected to PCI local bus 140 through I/O fabric 180, which comprises switches and bridges. In a similar manner, PCI IOA 122 is connected to PCI local bus 141 through I/O fabric 181, PCI IOAs 123 and 124 are connected to PCI local bus 142 through I/O fabric 182, and graphics adapter 148 and hard disk adapter 149 are connected to PCI local bus 143 through I/O fabric 183. The I/O fabrics 180-183 provide interfaces to PCI busses 140-143 and will be described in greater detail hereinafter. A typical PCI host bridge will support between four and eight IOAs (for example, expansion slots for add-in connectors). Each PCI IOA 120-124 provides an interface between data processing system 100 and input/output devices such as, for example, other network computers, which are clients to data processing system 100.

PCI host bridge 130 provides an interface for PCI bus 140 to connect to I/O bus 112. This PCI bus also connects PCI host bridge 130 to service processor mailbox interface and ISA bus access pass-through logic 194 and I/O fabric 180. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 are connected together to an interrupt input signal of the service processor. The service processor 135 has its own local memory 191, and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At completion of this step, service processor 135 has an inventory and topology understanding of data processing system. 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using an IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

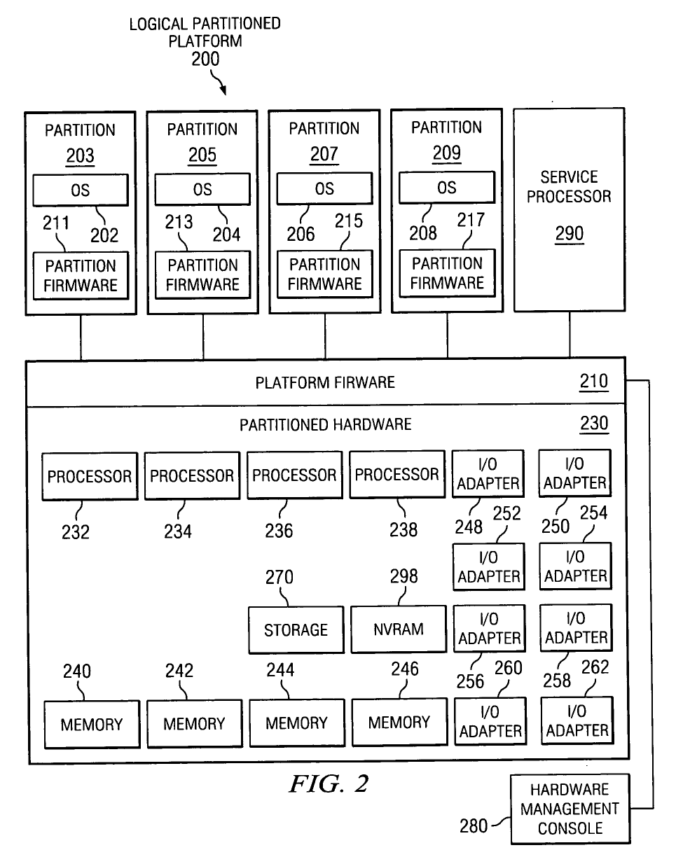

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor. OS/400 is used only as an example in these illustrative embodiments. Other types of operating systems, such as AIX and Linux, may also be used depending on the particular implementation. Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232-238, a plurality of system memory units 240-246, a plurality of IOAs 248-262, and a storage unit 270. Each of the processors 232-238, memory units 240-246, NVRAM storage 298, and IOAs 248-262, or parts thereof, may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

In an LPAR environment, it is not permissible for resources or programs in one partition to affect operations in another partition. Furthermore, to be useful, the assignment of resources needs to be fine-grained. For example, it is often not acceptable to assign all IOAs under a particular PHB to the same partition, as that will restrict configurability of the system, including the ability to dynamically move resources between partitions.

Accordingly, some functionality is needed in the bridges that connect IOAs to the I/O bus so as to be able to assign resources, such as individual IOAs or parts of IOAs to separate partitions; and, at the same time, prevent the assigned resources from affecting other partitions such as by obtaining access to resources of the other partitions.

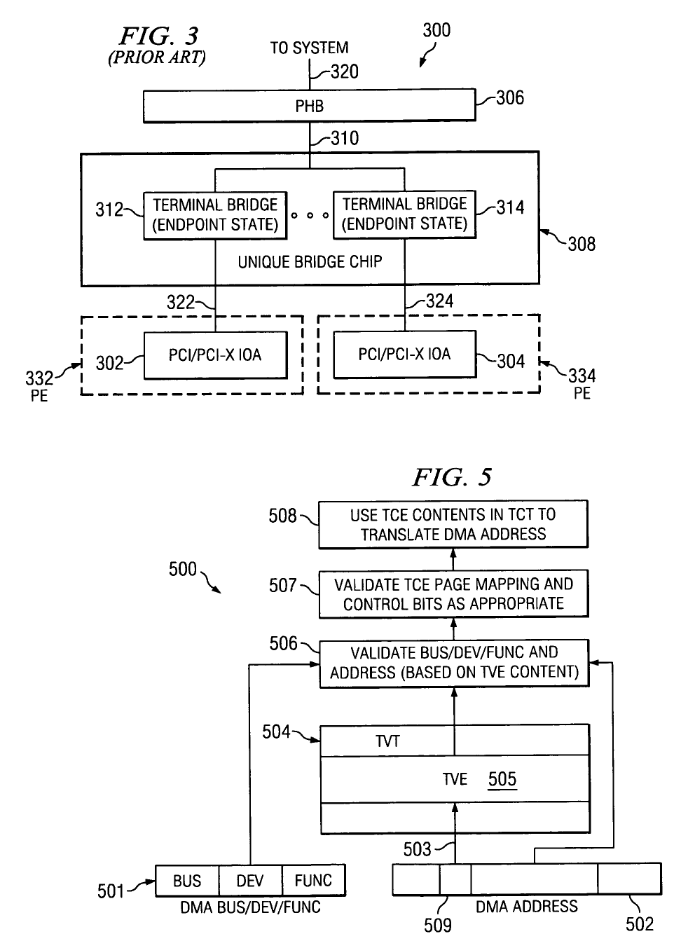

FIG. 3 is a block diagram that illustrates a known system for providing resource isolation in a data processing system to assist in explaining the present invention. The system is generally designated by reference number 300, and includes a plurality of IOAs, for example, IOAs 302 and 304. IOAs 302 and 304 are connected to PHB 306 of a data processing system, such as data processing system 100 illustrated in FIG. 1, through a bridge structure that comprises unique, specially designed bridge chip 308. Bridge chip 308 is connected to PHB 306 by PCI local bus 310, and PHB 306 is, in turn, ultimately connected to a system bus, such as system bus 106 in FIG. 1, possibly as through I/O bus 112 and I/O bridge 110 in FIG. 1, and to other components of the data processing system as represented at 320.

Unique bridge chip 308 includes a terminal bridge for each IOA. In particular, IOA 302 is connected to terminal bridge 312 by PCI bus 322, and IOA 304 is connected to terminal bridge 314 by PCI bus 324. Terminal bridges 312 and 314 contain endpoint states of IOAs 302 and 304, respectively, and serve to isolate IOAs 302 and 304 from one another.

In resource isolation system 300 illustrated in FIG. 3, IOAs 302 and 304 comprise input/output units that are capable of being isolated from one another in unique bridge chip 308; and, therefore, can, for example, be assigned to different partitions of an LPAR data processing system. An input/output unit that can be isolated from other input/output units of a data processing system and that can be separately assigned to different partitions of an LPAR data processing system is referred to herein as a “Partitionable Endpoint” or a “PE”. A PE, as used herein, is defined as being any part of an I/O subsystem that can be assigned to a partition independent of any other part of the I/O subsystem. Thus, in resource isolation system 300 in FIG. 3, each IOA 302 and 304 can also be considered as PEs 332 and 334, respectively.

As will become apparent hereinafter, a PE as defined herein also comprises an input/output unit that is something more or something less than a single IOA. For example, a PE also comprises a plurality of IOAs that function together and, thus, that should be assigned as a unit to a single partition. A PE can also comprise a portion of a single IOA, for example, two ports of a chip that perform as separately configurable functions. If the two ports provide separate functions, they are capable of being separately assigned to different partitions; and, thus, each port may be defined as a separate PE. In general, a PE is defined by its function rather than by its structure.

The present invention utilizes the concept of a PE to provide a resource isolation system in which the isolation functionality is moved from a unique bridge chip located externally of the PHB, such as in system 300 in FIG. 3, to the PHB itself.

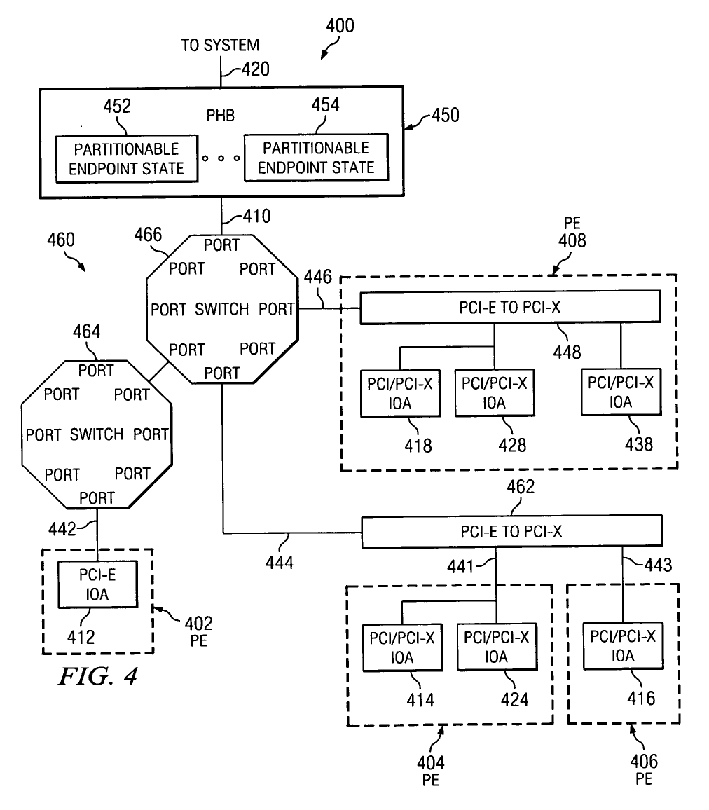

In particular, FIG. 4 is a block diagram that illustrates a system for providing resource isolation in a data processing system in accordance with a preferred embodiment of the present invention. The system is generally designated by reference number 400, and comprises a plurality of PEs 402, 404, 406 and 408 that are capable of being assigned to different partitions of an LPAR data processing system. PEs 402, 404, 406 and 408 are each connected to PHB 450 by an I/O fabric that is generally designated by reference number 460.

I/O fabric 460 includes PCI bridge 462 and switches 464 and 466, and is connected to PHB 450 by local PCI bus 410 that connects switch 466 to PHB 450, and to PEs 402, 404, 406 and 408 by various secondary busses. As shown in FIG. 4, PCI busses 410, 442, 444, and 446 are PCI-Express (PCI-E) links. In particular, as shown in FIG. 4, PE 402 is connected to PHB 450 by secondary bus 442, switches 464 and 466 and local bus 410. PE 404 is connected to PHB 450 by secondary bus 441, PCI bridge 462, secondary bus 444, switch 466, and local bus 410. PE 406 is connected to PHB 450 by secondary bus 443, PCI bridge 462, secondary bus 444, switch 466, and local bus 410. PE 408 is connected to PHB 450 by local bus 446, switch 466 and local bus 410.

It should be understood that the specific configuration of I/O fabric 460 illustrated in FIG. 4 is intended to be exemplary only. The I/O fabric can be assembled in any appropriate manner using any suitable arrangement of busses, bridges and switches. Also, it should be understood that one or more of PEs 402, 404, 406 and 408 can be connected directly to PHB 450 rather than being connected to PHB 450 through I/O fabric 460 as shown in FIG. 4.

PE 402 and PE 406 each comprises a single IOA 412 and 416, respectively, such that IOAs 412 and 416 can each be assigned to a different partition of the data processing system. PE 404 comprises two IOAs 414 and 424 that function together and, thus, must be assigned to the same partition. PE 408 comprises three IOAs 418, 428 and 438 and bridge 448 that function together and must be assigned to the same partition.

In isolation system 400, the endpoint states of each PE, referred to herein as Partitionable Endpoint states, are located in PHB 450 in the illustrated example rather than in a unique bridge chip as in system 300 illustrated in FIG. 3. As a result, in system 400, I/O fabric 460 can be assembled using inexpensive, industry standard switch and bridge chips, thus permitting a reduction in the overall cost of the data processing system while retaining all required isolation functions.

The ability to move the isolation functionality from a unique bridge chip to the PHB is achieved, in part, by providing a PE Domain Number that associates various domain components to the same PE. The PE Domain Number is an identifier that includes a plurality of fields that can be used to differentiate different IOAs in a PE. These fields include:
Bus number (Bus) field—the highest level of division. Each bus under a PHB has a unique bus number.
Device number (Dev) field within the Bus number—the next level of division. Each IOA on a bus has a different device number.
Function number (Func) field within the Device number—the lowest level of division. Each function of an IOA has a different function number (multiple function IOAs have multiple function numbers, and single function IOAs have one function number).

The PE Domain number (Bus/Dev/Func number), allows for division down to the lowest level of division i.e., use of all of the Bus/Dev/Func fields allows separate functions of a multiple function IOA to be differentiated. In isolation systems that do not require such a fine granularity, the PE Domain number can be defined by the Bus field alone, allowing differentiation between the PEs connected to the PHB, or by the Bus field together with either the Dev field or the Func field to permit differentiation between IOAs of a PE or differentiation between functions of an IOA in a PE that contains a multiple function IOA.

Among the isolation functionality provided by PHB 450 in FIG. 4 includes functionality to isolate Direct Memory Access (DMA) domains. In particular, among the platform resources that may be allocated to different partitions in an LPAR data processing system include regions of system memory. In such an environment, it is important that the platform provide a mechanism to enable a PE to obtain access to all the physical memory that it requires to properly service the partition to which it has been assigned; while, at the same time prevent the PE from obtaining access to physical memory that has not been allocated to its partition.

Physical memory assigned to different partitions is interspersed throughout the physical memory address range of a platform. Accordingly, it is not realistic for a PE to be given direct access to a physical memory address from an I/O bus address, and, at the same time, effectively prevent the PE from gaining access to memory that it is not supposed to access.

The resource isolation system of the present invention includes mechanisms in the PHB that provide the following isolation functionalities:

1. a functionality to validate whether a PE has the authority to access an I/O bus address range, and to prevent a DMA operation if access is not validated;

2. a functionality that ensures that a PE is not able to access a range of addresses greater than what it is allowed to access; and

3. a functionality that allows the Hypervisor of the data processing system to hide the physical system memory address from the PE and the partition to which it has been assigned.

The above isolation functionalities are enabled by providing a Translation Validation Table (TVT) and a Translation and Control Table (TCT) in the PHB. The TVT is used in conjunction with the PE Domain Number (Bus/Dev/Func number) of a PE seeking access to a particular memory address range. Different I/O bus address ranges in the data processing system memory are associated with different PE Domain Numbers, and I/O bus access is controlled by using the TVT to match the PE Domain Number of a PE requesting memory access with the PE Domain Number associated with the I/O bus address range for which access is requested. The TCT is used to virtualize the I/O bus address range to corresponding memory addresses.

More particularly, the Translation Validation Table (TVT) in the PHB is a table of entries referred to as Translation Validation Entries (TVEs), each of which is assigned to a single PE. A specific TVE is selected by the address provided by the DMA operation, which comprises the PE Domain Number and the bus address. Those skilled in the art will recognize that there are several ways to get from this address provided by the PE to a unique entry in the TVT. For example, the PHB may index into the TVT by a field in the I/O bus address that is generated by the PE (the TVE Index field). When a PE puts out an I/O bus address requesting access to a memory range, the TVE Index field is used to index into the TVT. Those skilled in the art will understand that the lookup in the TVT could also be performed by other methods such as using the Bus/Dev/Func itself from the transaction, and creating a lookup based on a hash table and hashing algorithm. If the Bus/Dev/Func stored in the TVE does not match the corresponding field(s) in the incoming I/O bus transaction, then the DMA operation is not allowed to proceed and is aborted. If the operation is valid, then the Translation Control Entry (TCE) in the TCT is used to validate the operation further and to translate the validated I/O bus address.

FIG. 5 is a block diagram that illustrates the general flow of a DMA operation in accordance with a preferred embodiment of the present invention. The DMA operation is generally designated by reference number 500 and begins with DMA address 502 and Bus/Dev/Func number 501 coming in on the I/O bus of the data processing system; The Bus/Dev/Func number uniquely identifies the entity that is requesting memory access. An index field 509 is included in DMA address 502, and is used to access TVE 505 in TVT 504, as indicated by arrow 503. TVE 505 contains an 8-bit bus number field and a 3-bit bus number validate field. Optionally, TVE 505 may also include a 5-bit device number field and a 1-bit device number validate field, and/or a 3-bit function number field and a 1-bit function number validate field. These fields are used to determine if the Bus/Dev/Func 501 coming in with the transaction has valid access to the TVE that it is trying to access. If not, the DMA operation is prevented.

DMA address 502 is then checked to see if it exceeds what TVE 505 says is valid as shown at 506. This is done by using a TVE Table Size (Address Size) field of TVE 505 to determine how many high-order bits of the TCE Index Field of DMA address 502 have to be zero. If the address is too large, the access is not valid. Also, if the TCE Table Size is zero, then the TCE is invalid and, therefore, the access is invalid. This procedure ensures that the PE does not try to access a range of addresses that is greater than it is allowed to access.

If validation 506 completes without error, and the I/O Page Size field in TVE 505 is not zero, then the TCE is accessed and Page Mapping and Control bits in the TCE are checked as shown at 507 to see if the operation matches appropriately with the TCE. If so, the TCE is used to translate the DMA address as shown at 508. Otherwise, the operation is invalid. This process hides the actual physical memory address from the PE to help further isolate the addressing domains of the PEs.

If the above validation operation completes without error, and I/O Page Size field in TVE 505 is zero, then no address translation is performed on the address.

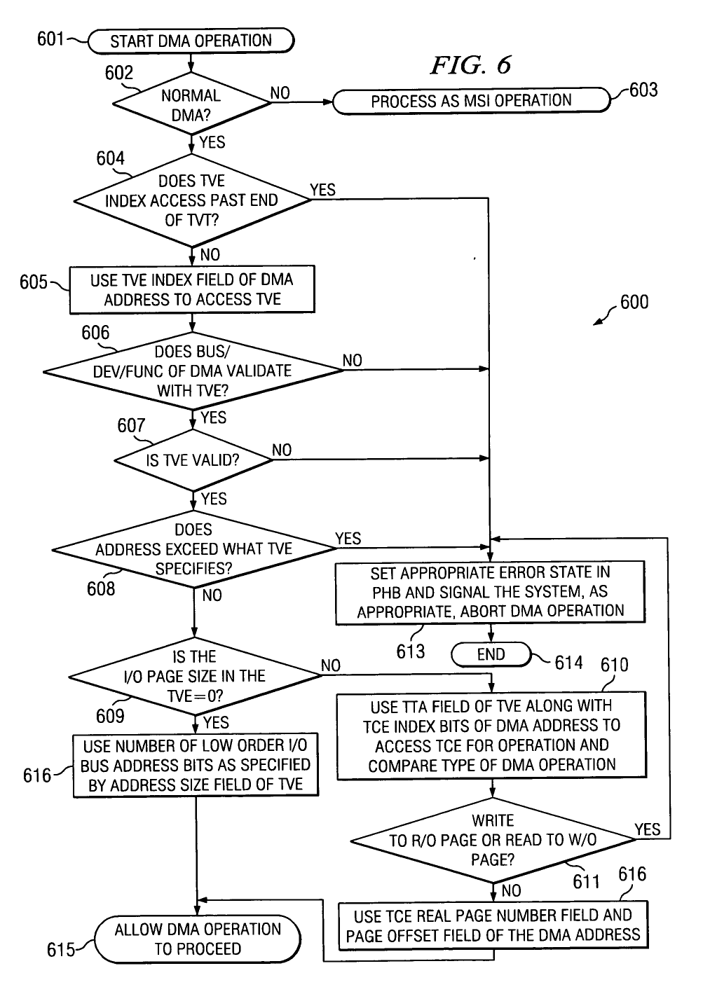

FIG. 6 is a flowchart that illustrates a method for isolating PEs from one another in accordance with a preferred embodiment of the present invention.

The method is generally designated by reference number 600 and begins by starting the DMA operation (step 601). A determination is then made as to whether this operation is a DMA or an MSI (Message Signaled Interrupt-signaled by a write to a particular address)(step 602). This determination is made by looking at a designated bit in the DMA address. In the illustrated embodiment described herein, zero indicates a normal DMA operation and one indicates an MSI operation. If it is an MSI operation (No output of step 602), the operation is processed as an MSI operation (step 603).

If the operation is a DMA operation (Yes output of step 602) a determination is made as to whether the TVE Index Field from bits in the I/O address will access beyond the end of the TVT that is implemented (step 604). If Yes, then error handling is performed (step 613), and the method ends (step 614).

If the output of step 604 is No, the TVE Index field of the DMA address is then used to access the TVE (step 605). In particular, the 8-bit bus number field and 3-bit Bus number validate field of the TVE are used to determine if the Requestor ID (as specified by the Bus/Dev/Func number in the DMA operation) has access to TVE 506. The bus number validate field of the TVE is used to indicate how many of the low-order bus number field bits are ignored in the comparison process, thus allowing for a range of bus numbers to be combined together into one PE, as in PE 408 in FIG. 4. Optionally, if implemented, a 5-bit device number field and 1-bit device number validate field and a 3-bit function number field and 1-bit function number validate field may be used. The device number validate bit indicates whether or not to compare the device number fields, thus allowing a range of devices to be combined together into one PE, as in PE 404 in FIG. 4, when the device number field is implemented in the TVE. The function number validate bit indicates whether or not to compare the function number fields, thus allowing multiple functions of a multi-function IOA to be combined into one PE when the function field is implemented in the TVE. If the Bus/Dev/Func number does not validate (No output of step 606), then error handling is performed (step 613) and the method ends (step 614).

If the Bus/Dev/Func number does validate (Yes output of step 606), the TVE is then checked to see if it is valid (step 607). TVE validity is verified by checking to make sure that the TCE Table Size (Address Size) field is non-zero. If the TVE is not valid (No output of step 607), error handling is performed (step 613) and the method ends (step 614).

If the TVE is valid (Yes output of step 607), the address is then checked to see if it exceeds what the TVE specifies as being valid (step 608). This is done by using the TVE Table Size (Address Size.) field to determine how many of the high-order bits of the TCE Index field of the DMA address have to be zero. If the address is too large (Yes output of step 608), the access is not valid, error handling is performed (step 613) and the method ends (step 614). If the TCE Table Size is zero, then the address will always be deemed to be invalid, so a value of zero can be used to mark the TVE as invalid with a good Bus/Dev/Func validation.

If the address is not too large (No output of Step 608), the I/O page size field in the TVE is checked to see if it is zero (step 609). If it is zero (Yes output of step 609), the TCE access and address translation is by-passed using the number of low order address bits from the I/O bus address as specified by the TCE Table Size (Address Size) field, and appending on the appropriate number of TCE Table Address (TTA) field low-order bits as the high-order bits of the real address to create enough bits to address the entire address range supported by the implementation (step 616), and the DMA operation is allowed to continue (step 615).

If the I/O Page Size field in the TVE is not zero (No output of step 609), then the TTA field of the TVE is used along with the TCE Index bits of the DMA address to access the TCE for the operation (step 610).

A comparison is made with the type of DMA operation (read or write) to the TCE Page Mapping and Control field of the TCE (step 611). If the type of operation does not match, or if the Page Mapping and Control field indicates a page fault (Yes output of step 611), then error handling is performed (step 613) and the method ends (step 614).

The Real Page Number field of the TCE is used along with the Page Offset field of the incoming DMA address to construct the physical address to be used to access system memory (step 612), and the operation is allowed to continue (step 615).

The present invention thus provides a technique for isolating input/output adapter Direct Memory Access addressing domains in a data processing system. The technique implements address isolation capabilities of the PCI Host Bridge that enables endpoint states relating to IOAs to be moved to the PHB from specially designed, unique bridge chips external to the PHB as are typically used to provide address isolation functionality. The present invention thus permits the use of less expensive, industry standard bridges external to the PHB, providing a less costly data processing system.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A data processing system, comprising:
a system bus;
a host bridge connected to the system bus; and
a plurality of input/output units connected to the host bridge, wherein the host bridge includes functionality for isolating the plurality of input/output units from one another.

2. The system according to claim 1, wherein each input/output unit is identified by an identifier, and wherein the host bridge includes functionality for isolating the plurality of input/output units from one another using the identifier.

3. The system according to claim 2, wherein the identifier for each input/output unit includes at least a Bus number field that identifies its respective input/output unit.

4. The system according to claim 3, wherein the identifier for at least one of the plurality of input/output units further includes a Device number field that identifies an input/output adapter included in the at least one input/output unit.

5. The system according to claim 3, wherein the identifier for at least one of the plurality of input/output units further includes a Function number field that identifies a function of an input/output adapter included in the at least one input/output unit.

6. The system according to claim 2, wherein the host bridge includes a table having a plurality of entries, each of the plurality of entries capable of being assigned to a different input/output unit, and wherein the host bridge isolates the plurality of input/output units using the identifier and the table.

7. The system according to claim 1, further including a plurality of logical partitions, and wherein each of the plurality of input/output units are capable of being assigned to a different logical partition of the plurality of logical partitions.

8. The system according to claim 1, wherein each of the plurality of input/output units comprises one of an input/output adapter, a plurality of input/output adapters that function together and a portion of a multi-function input/output adapter.

9. The system according to claim 1, wherein the functionality includes functionality for isolating Direct Memory Access to a memory of the data processing system by the plurality of input/output units.

10. The system according to claim 1, wherein at least one of the plurality of input/output units is connected to the host bridge through an input/output fabric.

11. A data processing system, comprising:
a system bus;
a memory connected to the system bus;
a host bridge connected to the system bus; and
a plurality of input/output units connected to the host bridge, wherein the host bridge includes functionality for isolating Direct Memory Access to the memory of the data processing system by the plurality of input/output units.

12. The system according to claim 11, wherein each input/output unit is identified by an identifier, and wherein the host bridge includes functionality for isolating Direct Memory Access to the memory by the plurality of input/output units using the identifier.

13. The system-according to claim 12, wherein the identifier of each input/output unit includes at least a Bus number field that identifies its respective input/output unit.

14. The system according to claim 13, wherein the identifier of at least one of the plurality of input/output units further includes a Device number field that identifies an input/output adapter included in the at least one input/output unit.

15. The system according to claim 13, wherein the identifier of at least one of the plurality of input/output units further includes a Function number field that identifies a function of an input/output adapter included in the at least one input/output unit.

16. The system according to claim 12, wherein the host bridge includes a table having a plurality of entries, each of the plurality of entries capable of being assigned to a different input/output unit, and wherein the host bridge isolates Direct Memory Access to a memory of the data processing system by the plurality of input/output units using the identifier and the table.

17. The system according to claim 16, wherein different input/output bus address ranges of an input/output bus are associated with different input/output units, and wherein the host bridge includes functionality for comparing the identifier of an input/output unit seeking access to a particular input/output bus address range in the input/output bus with the an identifier of an input/output unit associated with the particular input/output bus address range.

18. The system according to claim 17, wherein the host bridge further includes functionality for ensuring that an input/output unit does not attempt to access an input/output bus address range greater than what it is allowed to access.

19. The system according to claim 17, wherein the host bridge further includes functionality for hiding a physical memory address of the data processing system from an input/output unit seeking access to a particular memory address range.

20. The system according to claim 11, further including a plurality of logical partitions, and wherein each of the plurality of input/output units are capable of being assigned to a different logical partition of the plurality of logical partitions.

21. The system according to claim 11, wherein at least one of the plurality of input/output units is connected to the host bridge through an input/output fabric.

22. A-method for isolating a plurality of input/output units in a data processing system from one another, the method comprising:
isolating the plurality of input/output units from one another at a host bridge to which the plurality of input/output units are connected.

23. The method according to claim 22, wherein each of the plurality of input/output units has an identifier, and wherein the isolating includes isolating the plurality of input/output units using the identifier.

24. The method according to claim 23, wherein the host bridge includes a table having a plurality of entries, each of the plurality of entries capable of being assigned to a different input/output unit, and wherein the isolating includes isolating the plurality of input/output units using the identifier and the table.

25. A method for isolating Direct Memory Access to a memory of a data processing system by a plurality of input/output units, the method comprising:
isolating Direct Memory Access to the memory at a host bridge to which the plurality of input/output units are connected.

26. The method according to claim 25, wherein each of the plurality of input/output units has an identifier, and wherein the isolating includes isolating Direct Memory Access to the memory by the plurality of input/output units using the identifier.

27. The method according to claim 26, wherein the host bridge includes a table having a plurality of entries, each of the plurality of entries capable of being assigned to a different input/output unit, and wherein the isolating includes isolating Direct Memory Access to the memory by the plurality of input/output units using the identifier and the table.

28. The method according to claim 27, wherein different input/output bus address ranges of an input/output bus are associated with different input/output units, and wherein the isolating includes comparing the identification of an input/output unit seeking access to a particular input/output bus address range in the input/output bus with an identifier of the input/output unit associated with the particular input/output bus address range.

29. The method according to claim 28, wherein the isolating further includes ensuring that an input/output unit does not attempt to access an input/output bus address range greater than what it is allowed to access.

30. The method according to claim 28, wherein the isolating further includes hiding a physical memory address of the data processing system from an input/output unit seeking access to a particular memory address range.

31. An apparatus for isolating a plurality of input/output units from one another in a data processing system the apparatus comprising:
a host bridge for connecting the plurality of input/output units to a system bus, the host bridge including functionality for isolating the plurality of input/output units from one another.

32. The apparatus according to claim 31, wherein each input/output unit includes an identifier, and wherein the host bridge includes functionality for isolating the plurality of input/output units from one another using the identifier.

33. The apparatus according to claim 32, wherein the host bridge includes a table having a plurality of entries, each of the plurality of entries capable of being assigned to a different input/output unit, and wherein the host bridge includes functionality for isolating the plurality of input/output units using the identifier and the table.

34. An apparatus for isolating Direct Memory Access to a memory of a data processing system by a plurality of input/output units, the apparatus comprising:
a host bridge for connecting the plurality of input/output units to a system bus, the host bridge including functionality for isolating Direct Memory Access to the memory by the plurality of input/output units.

35. The apparatus according to claim 34, wherein each input/output unit includes an identifier, and wherein the host bridge includes functionality for isolating Direct Memory Access to the memory using the identifier.

36. The apparatus according to claim 35, wherein the host bridge includes a table having a plurality of entries, each of the plurality of entries capable of being assigned to a different input/output unit, and wherein the host bridge includes functionality for isolating Direct Memory Access to the memory by the plurality of input/output units using the identifier and the table.

37. The apparatus according to claim 36, wherein the host bridge further includes functionality for ensuring that an input/output unit does not attempt to access a memory address range greater than what it is allowed to access.

38. The apparatus according to claim 37, wherein the host bridge further includes functionality for hiding a physical memory address of the data processing system from an input/output unit seeking access to a particular memory address range.
